(19) United States
(12) Patent Application Publication
(10) Pub. No.: US 2016/0049841 A1
(43) Pub. Date: Feb. 18, 2016

(54) COIL FOR AXIAL FLUX PM-MOTOR

(71) Applicant: GREENWAY ENERGY AS, Trondheim (NO)

(72) Inventor: Jon EIRIK BRENNVALL, Trondheim (NO)

(73) Assignee: Greenway Energy AS, Pirsenteret (NO)

(21) Appl. No.: 14/779,923

(22) PCT Filed: Sep. 9, 2013
(86) PCT No.: PCT/IB2013/060752

§ 371 Date: Sep. 24, 2015

(30) Foreign Application Priority Data
Dec. 3, 2012 (NO) 20121455

(51) Int. Cl. H02K 3/50; H02K 3/28; H02K 3/12; H02K 15/04

(52) U.S. Cl. CPC H02K 3/50; H02K 15/0478; H02K 15/0464; H02K 3/28; H02K 3/12

(57) ABSTRACT

The present publication relates to one or more coils for axial flux PM-motor according to the description where the coil(s) are made up of coil elements of lap type with slots where the coil element is manufactured by casting, or a combination off milling or punching and water cutting or wire cutting or similar. It is also made slots 101 for the connector which connects each coil element.

### SUMMARY

This patent is an extension of Patent WO 2012/128646 1A “Coil assembly for three phased transversal axial flux multi disk machines”, which includes machines with other phase numbers, winding patterns and manufacturing techniques.

WO 2012/1286461A describes how a 3 phased axial flux PM-motor can be made from coil elements where you get a completely flat coil by making cuts in the thread so the coil elements fit together in a jigsaw.

The most important new in this patent application contra WO 2012/128646 1A is general claims on other types of coils and optimal solutions for coil shape and production methods.

### DESCRIPTION

In this patent we keep the numbering from patent WO 2012/128646 1A but new details has numbering form 100-111. New figures have numbering from 20-28.

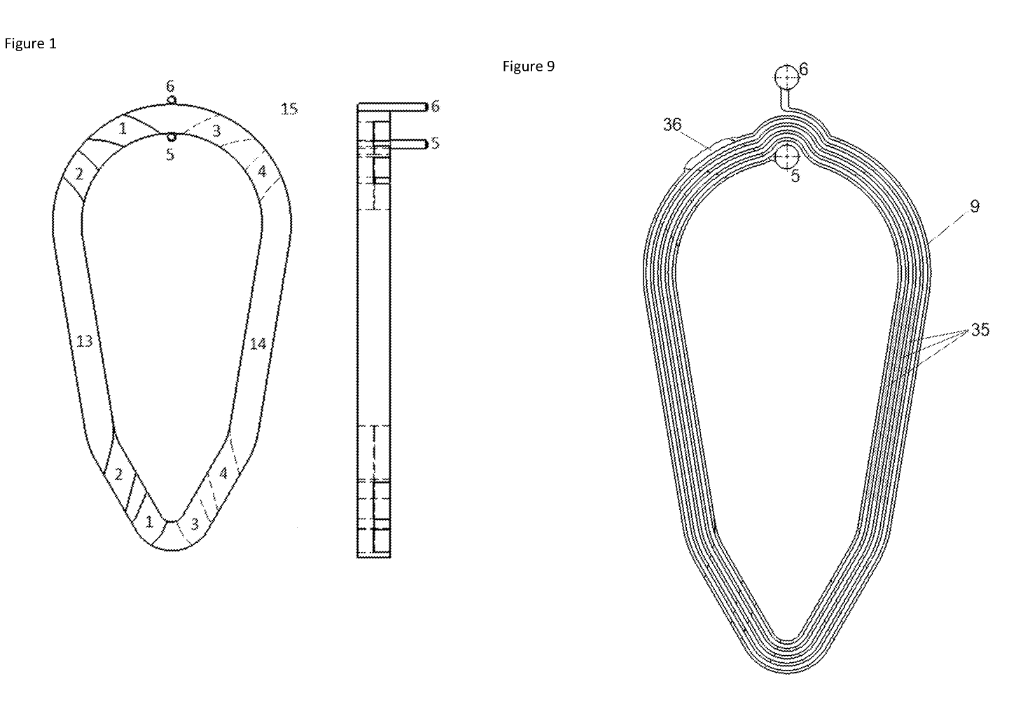

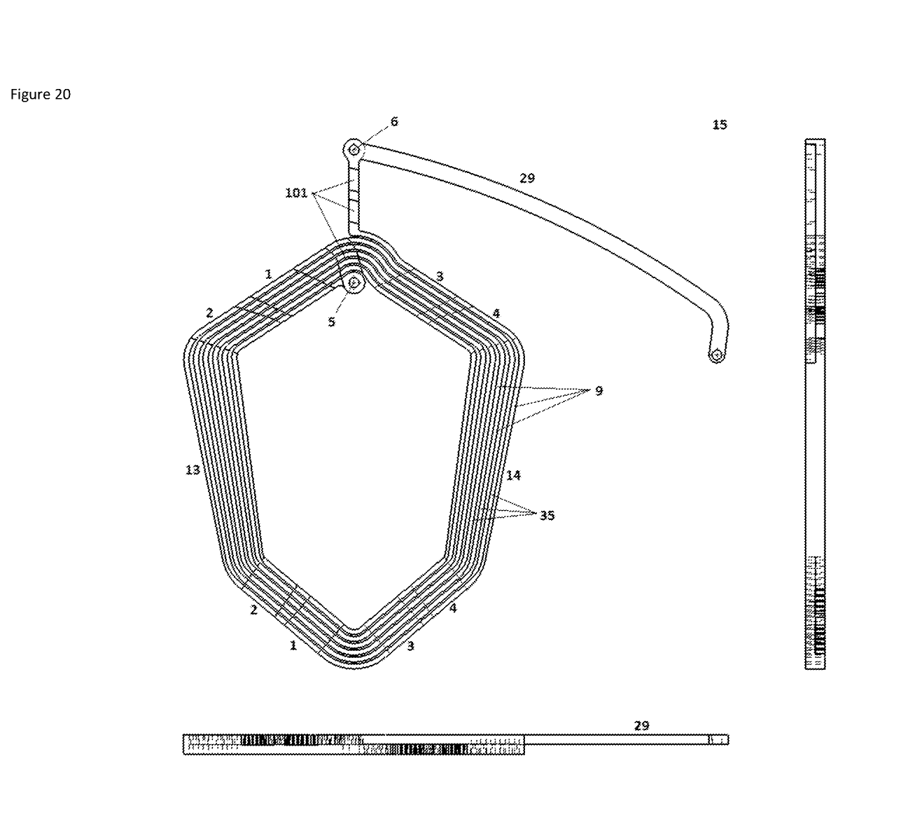

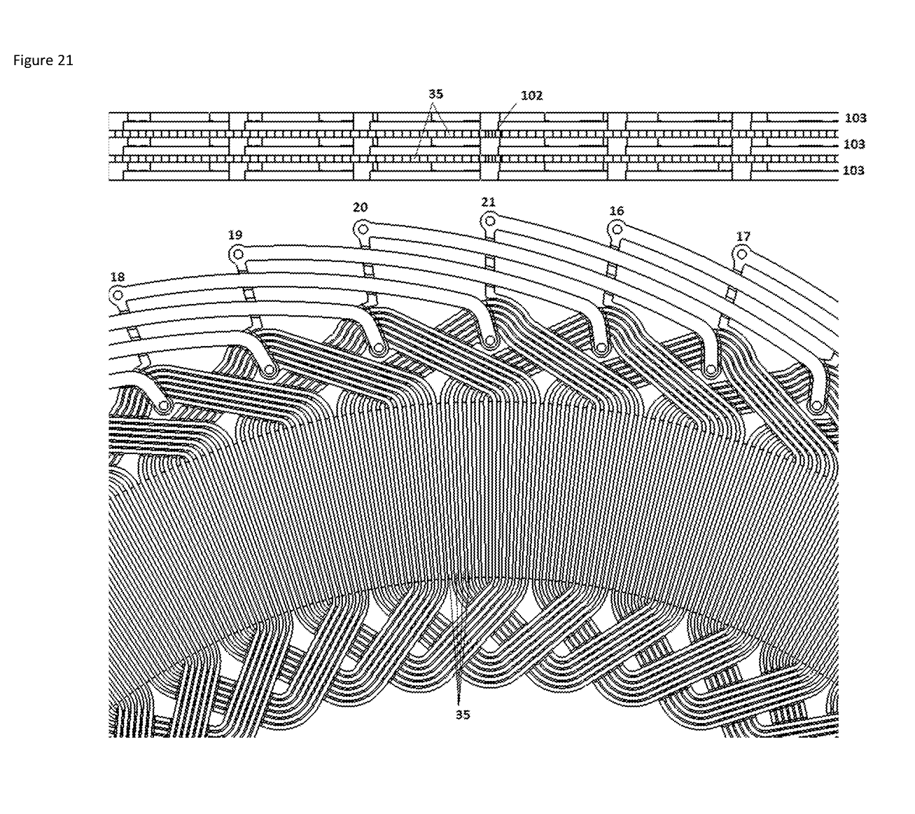

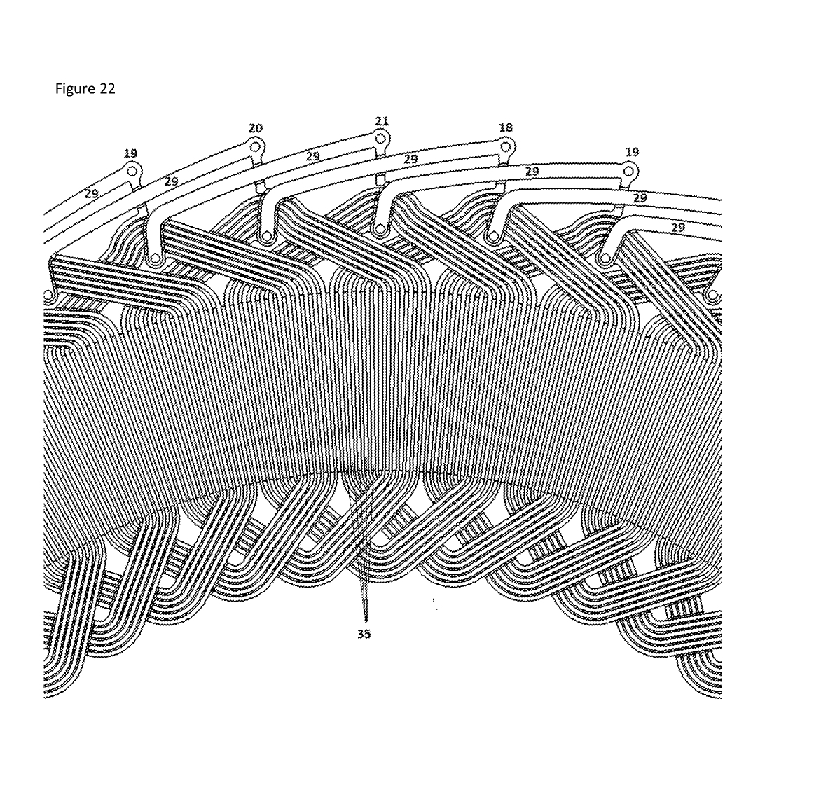

FIG. 20 show the same type of coil element as FIGS. 1 and 9. The new details here are:
the connector 29 is made part of the coil element 15. This eliminates one contact point.
It is made slots 101 for connector 29 and the connector 29 is given a thickness so it fit into the slot 101. This ensures that the connector does not build extra thickness compared to the coil. It is three slots 101 for connectors from three other coil elements. This coil is lap winding of AA-BB-CC type meaning that two adjacent coil legs 13, 14 belong to the same phase. Then it is necessary with 4 coil slots 1-4 both at top and bottom of each coil element 15.

Slots with the same number contain wires from the same phase. This holds for all coil slot numbering.

Coil element 15 can be made by casting or a combination off milling or punching and water cutting or wire cutting. This allows the conductor 9 in the active area under the magnet to have varying thickness. Note how the thickness increases with distance from motor shaft centre line. This gives increased current density and increase heat generation closer to centre, but this heat is very effective distributed along the conductor so it is net heat generated in the conductor which counts.

FIG. 21 show a complete assembly based new configuration of coil elements 15. Coil element 16 and 19 belongs to phase 1, coil elements 17 and 20 belongs to phase 2 and coil elements 18 and 21 belongs to phase 3. Note that the wires in the paired elements are mirrored so the current can go in the same direction in up to 6 consecutive coil legs 13 and 14. This gives a lower pole number.

Note how the Iron 35 is visible between the coil layers 103. Also note the gap 102. It is difficult to recognize this on a standard patent drawing, but it is possible to see right through the coil through this gap. There are only 4 gaps visible on this view but there are of course gaps everywhere which cooling fluid can go through.

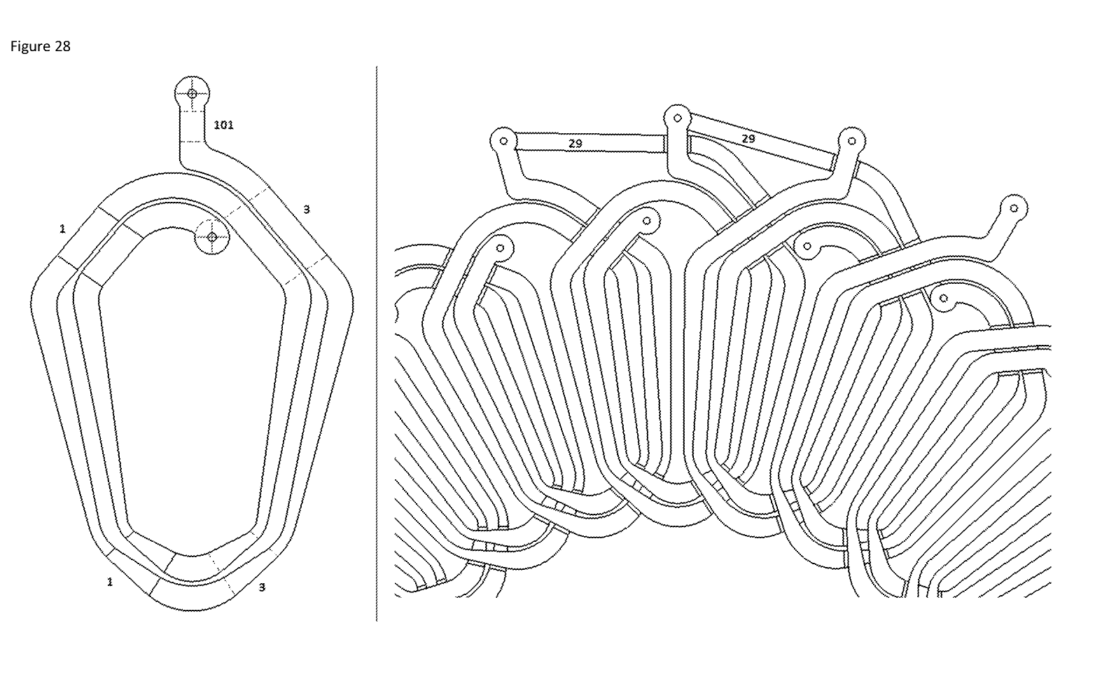

It is possible to make slots in other types of coil elements to make other types of coils for axial flux machines. A small change is the two phase design show in FIG. 22. The coil is identical to FIG. 21 except that the connectors 29 connect every second coil element instead of every third. For this reason the coil elements are numbered 18-21 instead of 16-21 as in FIG. 21. This is not the preferred way to make a 2 phased motor because a 2 phased motor can be made with coil slots 1 and 3 only as shown in FIG. 28. This gives less end windings.

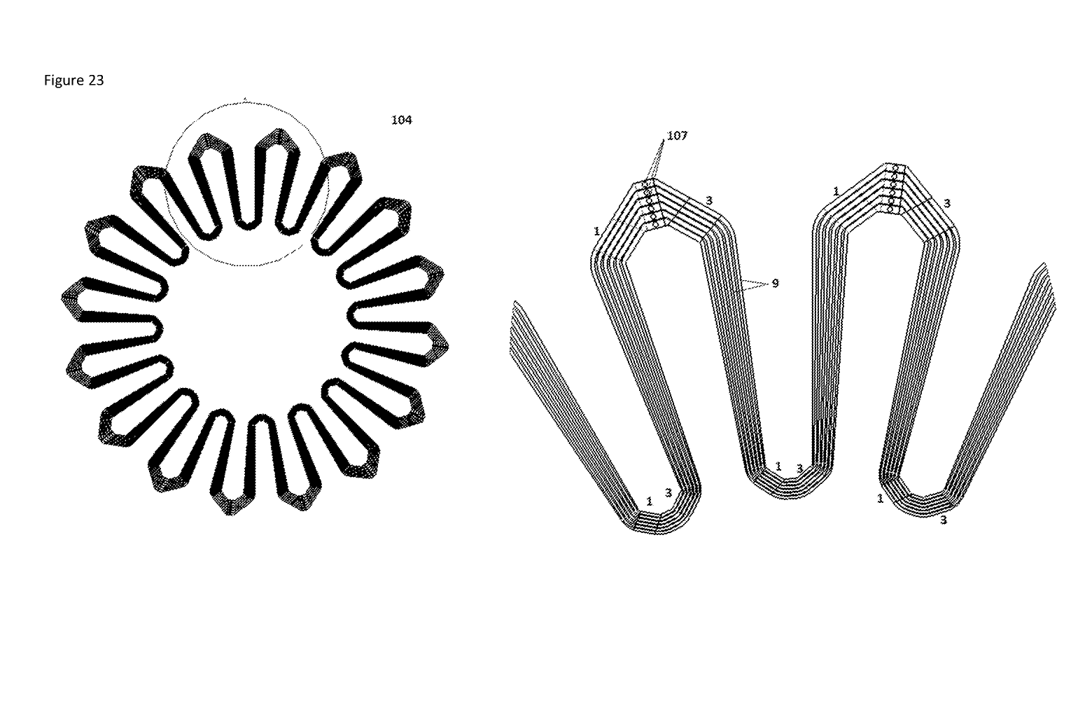

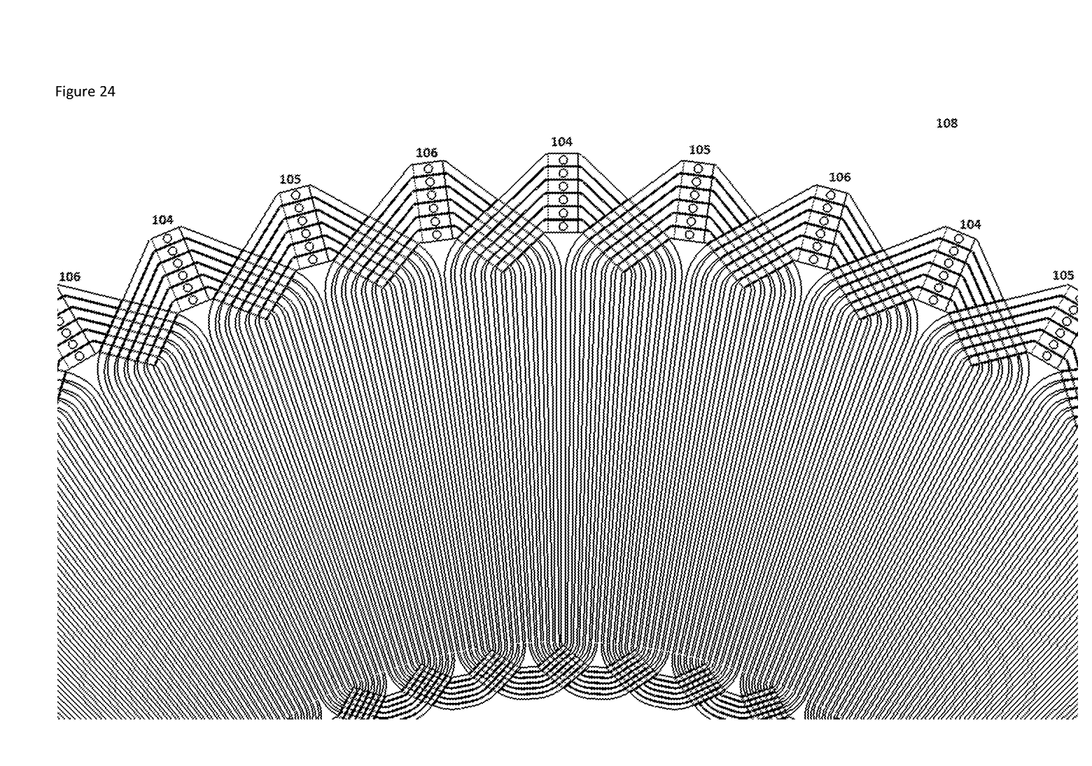

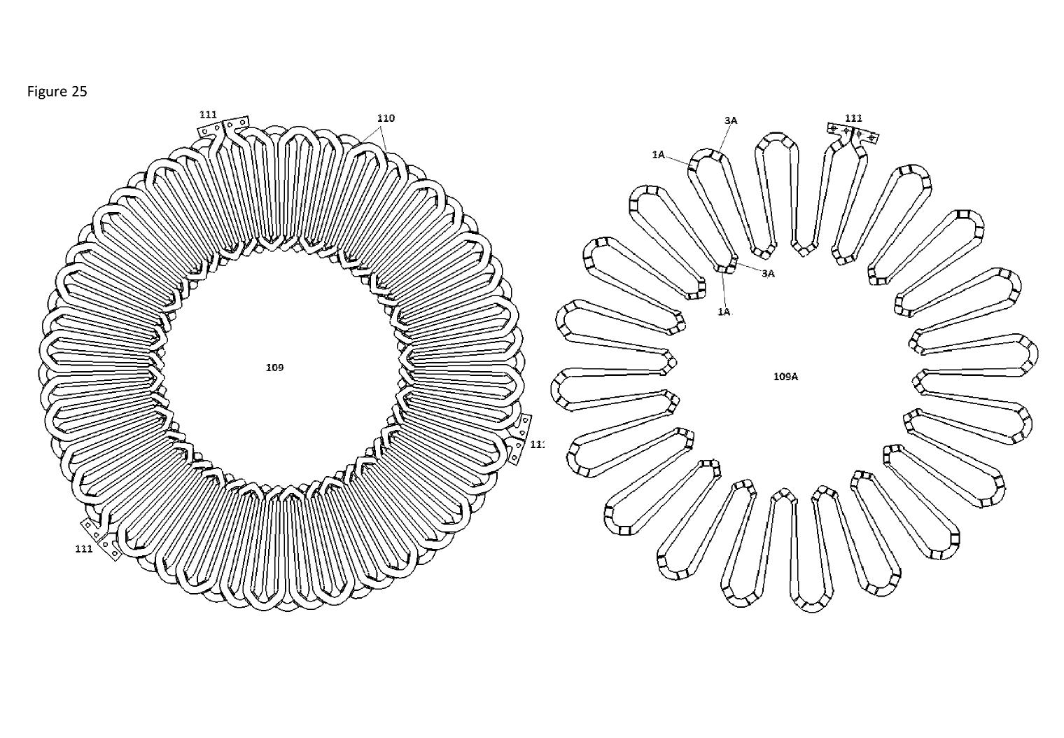

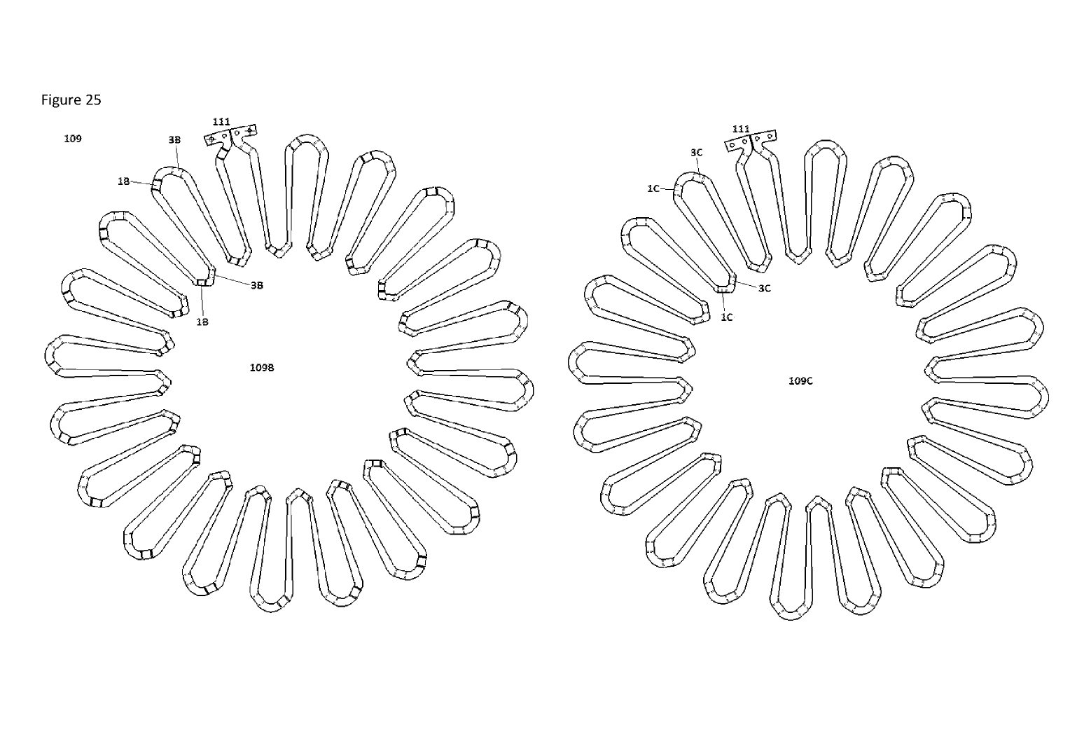

A more significant change would be coil of wave design. The advantage of wave windings is that you do not need the connectors you need in lap windings. FIG. 23 show one phase 104 of a coil for a 3 phased motor with 32 magnets on each rotor disk. This phase 104 can be cut in one single piece or you can make it of many elements if the machine is large. The holes 107 are for connecting coil elements.

FIG. 24 show the complete coil 108 made up of phase 104, 105 and 106. The coil 108 is wave winding of ABC-ABC type and only need only two slots 1,3 in each “coil element”. This gives smaller end windings but it also double the number of magnets poles on the rotor disk. This gives a penalty because the edge of the magnet contributes less than the centre to the magnetic field because of field leakage to the adjacent magnet.

FIG. 25 show a complete coil 109 of 3 phased wave winding type. Here the entire coil elements 109A-C consists of a single wire. Note that 109A has all the cuts 1A, 3A facing up. When assembling the coil 109 this coil element 109A is places first on the table. Coil element 109B has half of its cuts 1B facing up, and half of its cuts 3B facing down. This coil element 109B is placed on top of coil element 109A so the slots 1A and 3B goes into each other. The coil element 109C goes is placed on the table last. The slots 1C fits into slots 3A while slots 3C fits into slot 1B. The advantage of this design is that it is possible to assemble the coils easily. Theoretically a wave coil consisting of identical coil elements could be assembled but is would require that the coil elements was braided together or that all 3 elements was manufactured at the same time by metal printing techniques, and that is not practical. Small plastic pieces 110 or similar is placed in the cuts 1 and 3 to provide extra electric insulation in the cuts. The coil contacts 111 are placed on outside the coil, making this a motor/generator with a rotating centre shaft. Had the coil contacts 111 been placed on the inside of the coil, the coil would have been suited as a wheel motor.

To get a two phased machine coil element 109B can be skipped from the coil 109. The slots which then are not filled can then also be skipped. If coil element 109A and 109C is used directly there will be open space in coil 109, but it is easy to imagine how the slots must be moved to make an optimal two phase coil.

The lap winding coils shown in FIG. 20-23 and FIG. 28 can be assembled but inserting the last coil element to finish the coil can be a little tricky because it requires wide tolerances and some bending to get the last coil elements together. Imagine that you make a circle of standing domino pieces arranged so that if you tip any piece all will fall. Then tip one piece. Now if you want to remove one fallen piece you will have to lift another piece. Finishing the coils in FIG. 20-23 is similar to put the removed domino piece back, but more complicated because of the slots. You have to bend a large part of the entire coil to get the last elements 15 in place. For large coils for e.g. wind turbines generators this is undesirable because it makes assembly and disassembly nearly impossible.

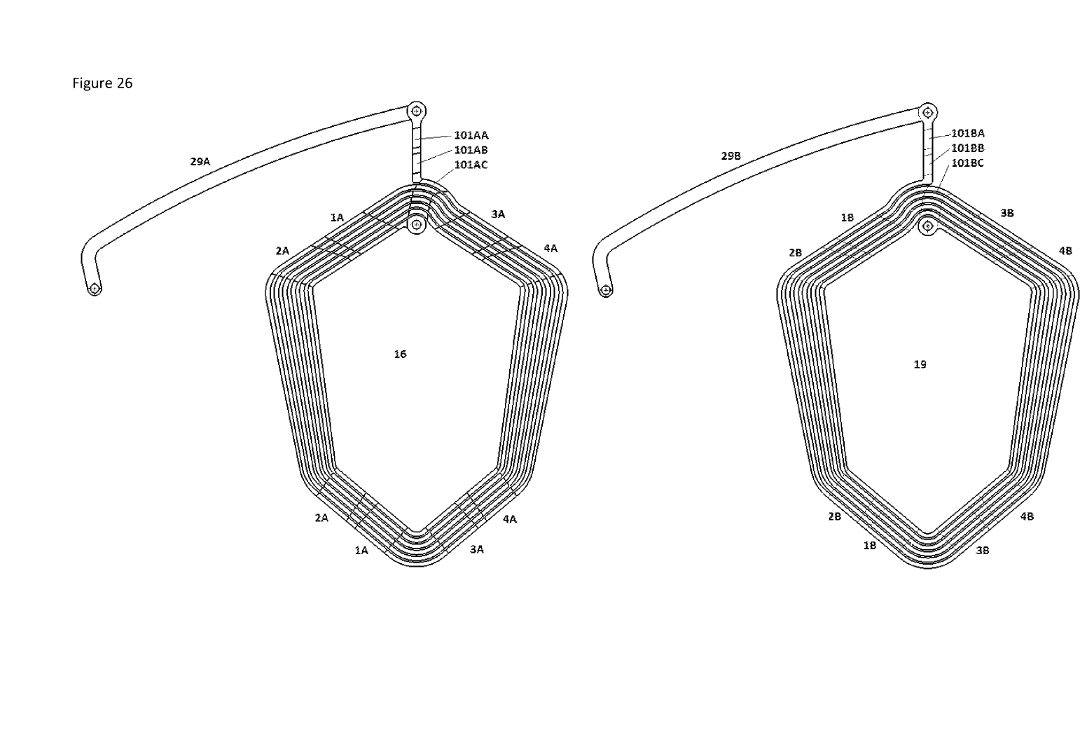

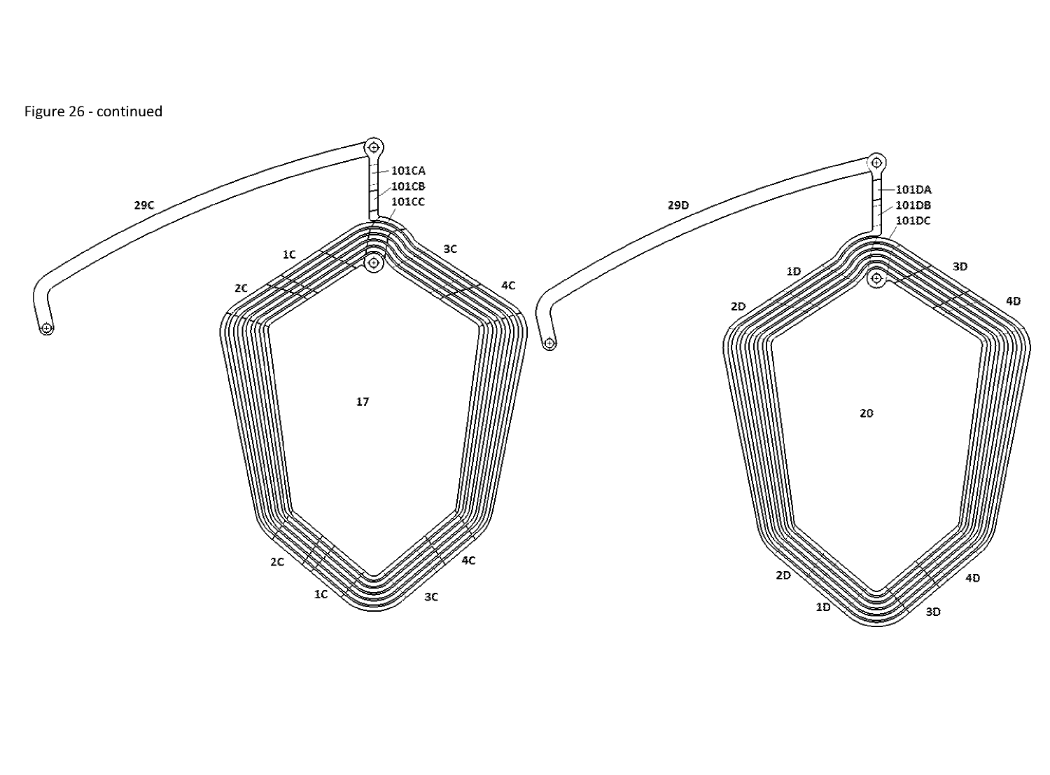

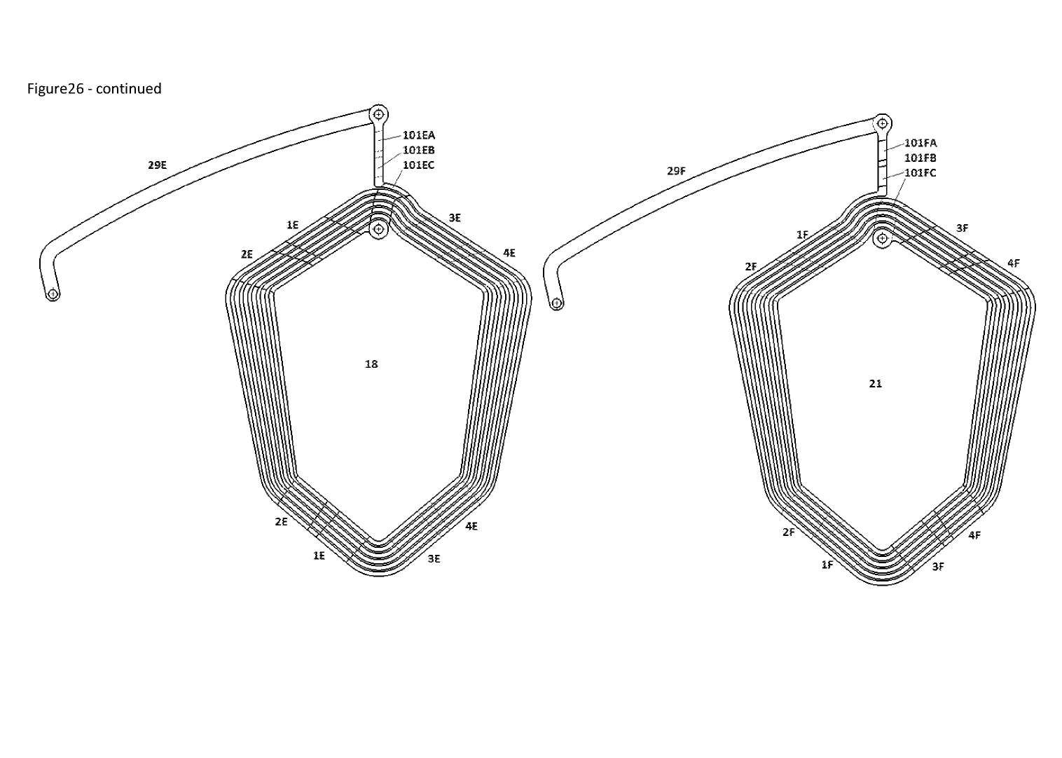

The idea of changing the slots in some of the coil elements 15 to make assembly easier is also applicable to lap winding. This gives more types of coil elements, but also easier assembly. An example of this is shown in FIG. 26. This is a tree phase coil made of lap windings. The coil elements are given 6 different shapes 16-21.

For coil element 16 is shaped so that all coil slots (1A-4A) and all the connector slots 101AA-101AC are all facing up on the figure. The connector 29A is along the table. For coil element 19 is shaped so that all coil slots (1B-BA) and all the connector slots 101BA-101BC are all facing down on the figure. The connector 29B is in the air. Coil elements 16 and 19 belong to phase 1.

For coil element 17 is coil slot 3B is facing down while the rest of the coil slots 1B,2B and 4B are facing up. Connector slot 101CA is facing down while connector slot 101CB and 101CC are facing up. The connector 29C is along the table. For coil element 20 is coil slot 3D is facing up while the rest of the coil slots 1D,2D and 4D are facing down. Connector slot 101DA is facing up while connector slot 101DB and 101DC are facing down. The connector 29C is in the air. Coil elements 17 and 20 belong to phase 2.

For coil element 18 is coil slot 3E and 4E is facing down while the rest of the coil slots 1E and 2E are facing up. Connector slot 101EA and 101EB is facing down while connector slot 101EC is facing up. The connector 29C is along the table. For coil element 21 is coil slot 3F and 4F is facing up while the rest of the coil slots 1F and 2F are facing down. Connector slot 101FA and 101FB is facing up while connector slot 101FC is facing down. The connector 29F is in the air. Coil elements 18 and 21 belong to phase 3.

That a slot is facing down means that it is not visible when seen as shown on FIG. 26. That the connector 29 is along the table means that the connector would touch the table when the coil elements are placed on a table as shown on FIG. 26. That the connector 29 is in the air means that the connector is not touching the table when the coil element 15 is placed on a table as shown in FIG. 26.

Note that coil element 16 and 19 are identical except for the connector.

Note that coil element 17 and 20 are identical except for the connector.

Note that coil element 18 and 21 are identical except for the connector.

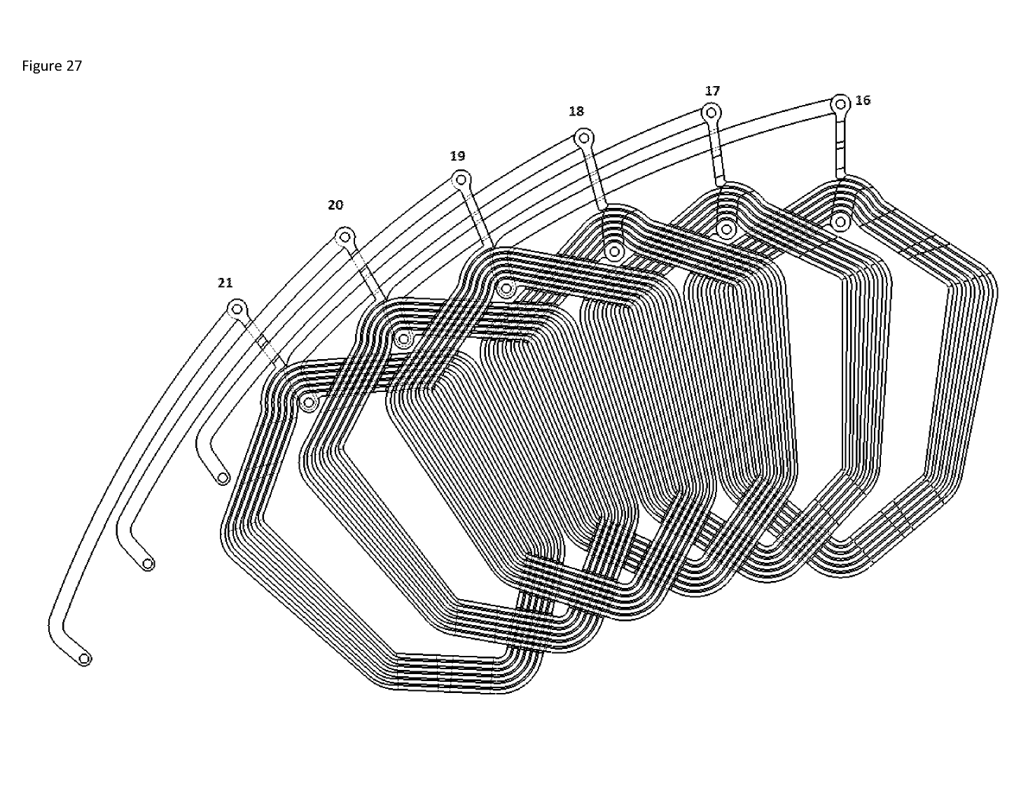

This means that if the connector are manufactured separate 3 types of coil elements are enough. However this will give twice as many contacts. The assembled coil elements are shown in FIG. 27.

For a two phased motor the same arrangement as shown in FIG. 27 the coil elements will only have two slots. Including connectors there will be 4 types of coil elements 15. Excluding connectors 2 type of coil elements 15 is enough. Similar arrangements can also be made for 4 and more phased motors, but it is doubtful that 4 or more phased machines with this kind of coils will be made because the end windings will be unacceptable large.

There are more possible coil configurations for axial flux machines. These configurations can be made completely flat by making coil elements with slots which fit into a flat 3D jigsaw as described here and in patent WO 2012/128646 1A.

1. Coil for axial flux PM-motor where the coil(s) are made up of coil elements of lap type with slots where the coil element is manufactured by casting, or a combination off milling or punching and water cutting or wire cutting or similar characterized by that it is also made slots for the connector which connects each coil element.

2. Coil for axial flux PM-motor according to claim 1, characterized by that the connector which transport current from one coil element to the next in same phase is attached to the coil elements to reduce number of contacts.

3. Coil assembly according to claim 1, characterized by that the depth of the slot and the connector thickness is adjusted so the entire coil including connectors have the same thickness.

4. Coil assembly according to claim 1, used in a 3 phased machine characterized by that the coil is made up of 3 different types of coil elements excluding connectors distinguished by how the coil slots are placed on the coil element which allows the coil to be assembled with only translator motion of the coil elements.

5. Coil assembly according to claim 1, used in a 3 phased machine characterized by that the coil is made up of 6 different types of coil elements including connectors distinguished by how the coil slots, connector and connector slots are placed on the coil element which allows the coil to be assembled with only translator motion of the coil elements.

6. Coil assembly according to claim 1, used in a 2 phased machine characterized by that the coil is made up of 2 different types of coil elements excluding connectors with all slots on one side which allows the coil to be assembled with only translator motion of the coil elements.

7. Coil for 3 phased axial flux PM-motor where the coil(s) are of wave winding type and manufactured by casting, or a combination off milling or punching and water cutting or wire cutting or characterized by that the first phase which can be made up of a single coil element or assembled from smaller parts, have slots which all face up when placed on the assembly table and these slots are arranged so that the slots fit together with the slots which face down in the second coil element which has slots on both sides and the slots in the second element which face up, together with the slots in the first coil element which is not filled by slots in the second coil element are arranged so that they are filled with the slots in the third coil element which only has slots facing down and can be identical with the first coil element.

8. Coil for 2 phased axial flux PM-motor similar to claim 7, where the coil(s) are of wave winding type and manufactured by casting, or a combination off milling or punching and water cutting or wire cutting or characterized by that the coil is made up of two coil elements with slots which fits together.

9. Coil assembly according to claim 7, characterized by that each coil element can be split into several wires which can be connected with the number of contacts which are required.

10. Coil assembly according to claim 9, characterized by that the one place in the coil element the outer wire is connected with the one inside so the current runs in all wires.

11. Coil assembly according to claim 10, characterized by that one of the coil slots is made a little thicker so it is possible to connect a contact to the inner wire and get out the current.

12. Coil for axial flux PM-motor according to claim 11, characterized by that the conductor in the coil leg in the active area under the magnet is given a shape where the conductor has decreasing thickness with distance from the shaft centre line allowing flat packages of sheet metal iron to be placed between the connectors.
